(19) United States
(12) Patent Application Publication
(10) Pub. No.: US 2012/0038158 A1
(43) Pub. Date: Feb. 16, 2012

(54) WIND POWER GENERATING MODULE FOR USE WITH ELECTRIC SCOOTER

(76) Inventors: Tzeng-Yuan CHEN, Tamsui (TW); Yi-Ting Liao, Tamsui (TW)

(21) Appl. No.: 12/856,479

(22) Filed: Aug. 13, 2010

(51) Int. Cl. F03D 9/00; F03D 9/02

(52) U.S. Cl. 290/50; 290/55

(57) ABSTRACT

A wind power generating module for use with an electric scooter is disclosed. The wind power generating module is installed on an electric scooter and includes: at least one fan blade being driven to rotate by external air introduced into the wind power generating module while the electric scooter is moving; a disc type generator with a rotor configured to rotate in conjunction with the fan blades and generate electric power; a duct circumferentially disposed at an outermost portion of the fan blades and having an opening, the opening receiving the fan blades, wherein the opening has a front opening portion functioning as an inlet for the external air and a rear opening portion functioning as an outlet for the external air, the front opening portion being smaller than the rear opening portion; a front protective cover and a rear protective cover disposed at the inlet and the outlet, respectively.

### FIELD OF THE INVENTION

The present invention relates to wind power generating modules, and more particularly, to a wind power generating module for use with an electric scooter.

### BACKGROUND OF THE INVENTION

The greenhouse effect arising from global warming, coupled with the dwindling fossil energy resources, prompt countries around the world to endeavor to develop renewable energy, especially solar energy, wind power generation, and fuel cells. Among the aforesaid forms of energy, solar energy and wind energy are inexhaustible, pollution-free, and environmentally friendly. At present, power plants, vehicles, and motorcycles worldwide are fueled mostly by burning coal and fossil fuel and therefore emit carbon dioxide. Carbon dioxide thus emitted is one of the major causes of global warming. Hence, it is important to develop pollution-free and environmentally friendly energy. In this regard, electric motorcycles, a kind of low-pollution, low-noise, energy-saving, and environmentally friendly transport means, are drawing increasingly great attention from developed countries in Europe, North America, and Japan which are confronted with increasingly great pollution and a dwindling petroleum storage level. These countries believe that it is the time to develop electric vehicles. Although motorcycles nowadays still use internal combustion engines as a primary source of power, electric motorcycles will prevail in the foreseeable future due to technological advancement. Hence, it is imperative to apply wind power generation in electric motorcycles such that a wind power generating module can function as an auxiliary recharging device for use with an electric motorcycle and achieve the goal of enhancing the range and the energy-saving capacity of the motorcycle.

The prior art pertaining to the present invention is disclosed in Taiwan patents M279530 entitled Wind Power Generating Power Device for Use with Electric Vehicle, M367833 entitled Wind Power Recharging Device for Use with Electric Vehicle, M364014 entitled Power Replenishing Device for Use with Electric Vehicle, and M359437 entitled Multi-module Recharging Device for Use with Motorcycle. Also, the prior art pertaining to the present invention is disclosed in U.S. published patent applications 20030155464A1 entitled Device of wind electric power on transportation vehicles, 20050210858A1 entitled Scoop generator, and 20050211488A1 entitled Methods and devices to improve the electric and battery powered motorcycle. However, none of the aforesaid wind power generating devices disclosed in the prior art has a duct or features a perfect combination of blades and a power generator, thus restricting the efficiency of wind power generation.

U.S. Pat. No. 7,018,166B2, titled “Ducted Wind Turbine,” and U.S. Pat. No. 4,075,500, titled “Variable Stator, Diffuser Augmented Wind Turbine Electrical Generation System,” both have disclosed a wind turbine with duct design. However, the disclosed structure designs for wind turbines cannot be applied to a electric scooter.

In view of the drawbacks of the prior art pertaining to the present invention, the inventor of the present invention endeavors to improve the prior art and thus proposes a wind power generating module for use with an electric scooter. The proposed wind power generating module introduces external air thereinto while the electric scooter is moving so as for fan blades to be driven to rotate by a current of the air and comprises a duct for enhancing the rotational efficiency of the fan blades, thereby increasing the power generation capacity of a power generator.

### SUMMARY OF THE INVENTION

It is an objective of the present invention to provide a wind power generating module which comprises multiple blades each having a wing-shaped cross-section and an enlarged duct and thereby greatly enhances the output of electric power, and, as a result, the wind power generating module can function as an auxiliary recharging device for use with an electric scooter and achieve the goal of enhancing the range and the energy-saving capacity of the electric scooter.

Another objective of the present invention is to provide a wind power generating module which is portable and thus can be installed at any appropriate position of a motorcycle, such as above the motorcycle head and thus functioning as a semi wind shield, at a motorcycle handle, outside the motorcycle front board, or inside the motorcycle front board, thereby dispensing the need for changing motorcycle structure and shape. Furthermore, in addition to motorcycles, the wind power generating module of the present invention is configured for use with any moving objects, such as bicycles or vehicles, and configured to be placed outdoors, to enable nature air feeding, thereby driving a power generator to generate electric power and functioning as a power supplying device.

Yet another objective of the present invention is to provide a wind power generating module with a wheel hub, and the wheel hub is coupled to a disc type generator to thereby achieve modularization and cut costs.

In order to achieve the above and other objectives, the present invention provides a wind power generating module for use with an electric scooter, wherein the wind power generating module is disposed in an electric scooter, comprising: at least one fan blade being driven to rotate by external air introduced into the wind power generating module while the electric scooter is moving; a disc type generator with a rotor configured to rotate in conjunction with the fan blades and generate electric power; a duct circumferentially disposed at an outermost portion of the fan blades and having an opening, the opening receiving the fan blades, wherein the opening has a front opening portion functioning as an inlet for the external air and a rear opening portion functioning as an outlet for the external air, the front opening portion being smaller than the rear opening portion; a front protective cover and a rear protective cover disposed at the inlet and the outlet, respectively.

### BRIEF DESCRIPTION OF THE DRAWINGS

To enable persons skilled in the art to gain insight into the structures, features, and effects of use of the present invention, the present invention is hereunder illustrated with preferred embodiments in conjunction with the accompanying drawings, wherein:

FIG. 1A is a front view of a wind power generating module for use with an electric scooter according to the present invention;

FIG. 1B is a rear view of the wind power generating module for use with an electric scooter according to the present invention;

FIG. 2 is a perspective view of the wind power generating module for use with an electric scooter according to the present invention;

FIG. 3A is a schematic view of the wind power generating module installed on an electric motorcycle according to the present invention;

FIG. 3B is a schematic view of the wind power generating module installed on an electric bicycle according to the present invention;

FIG. 3C is a schematic view of the wind power generating module installed above the head of the electric motorcycle according to the present invention;

FIG. 4A is a perspective view of a fan blade of the wind power generating module for use with an electric scooter in an embodiment according to the present invention;

FIG. 4B is a cross-sectional view of the fan blade shown in FIG. 4A;

FIG. 4C is a schematic view of the fan blade of the wind power generating module for use with an electric scooter in a variant embodiment according to the present invention;

FIG. 5A is a cross-sectional view of a duct of the wind power generating module for use with an electric scooter, taken along line B-B of FIG. 2, in an embodiment according to the present invention;

FIG. 5B is a cross-sectional view of protruding portions additionally provided to the duct shown in FIG. 5A;

FIG. 6A is a cross-sectional view of the duct of the wind power generating module for use with an electric scooter in another embodiment according to the present invention; and

FIG. 6B is a cross-sectional view of the protruding portions additionally provided to the duct shown in FIG. 6A.

### DETAILED DESCRIPTION OF THE INVENTIONS

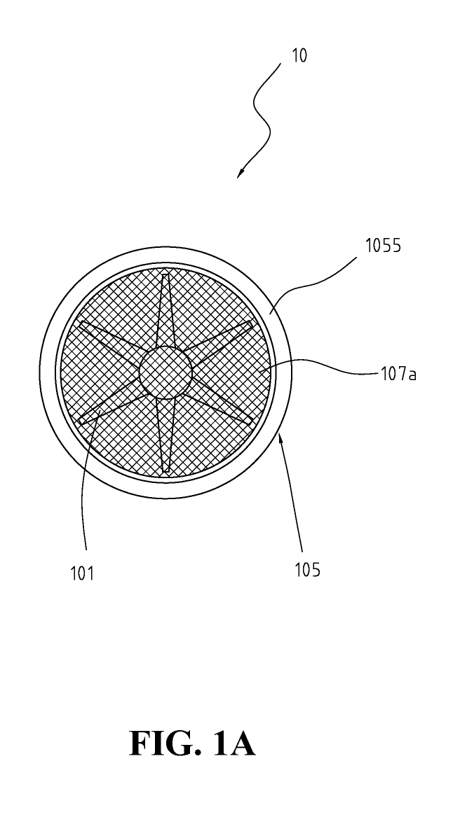

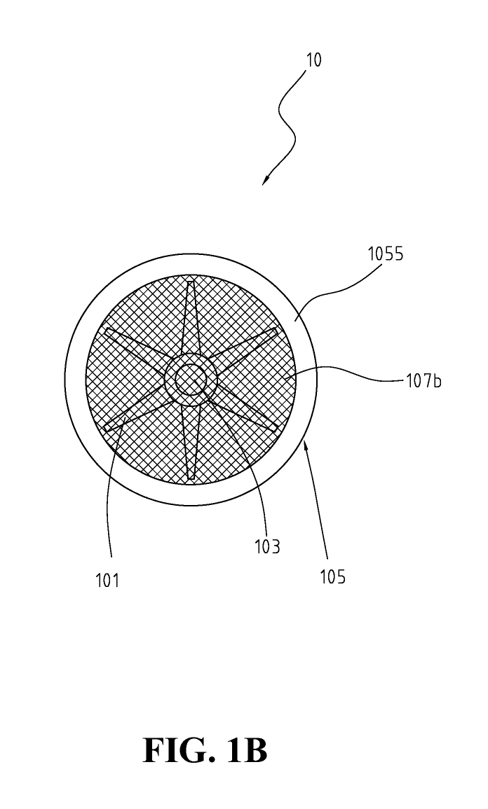

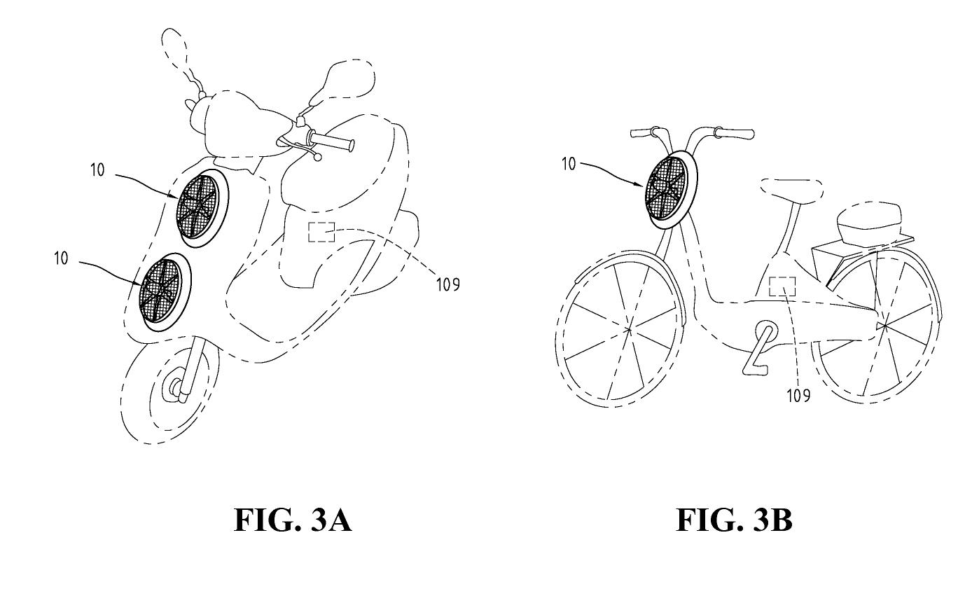

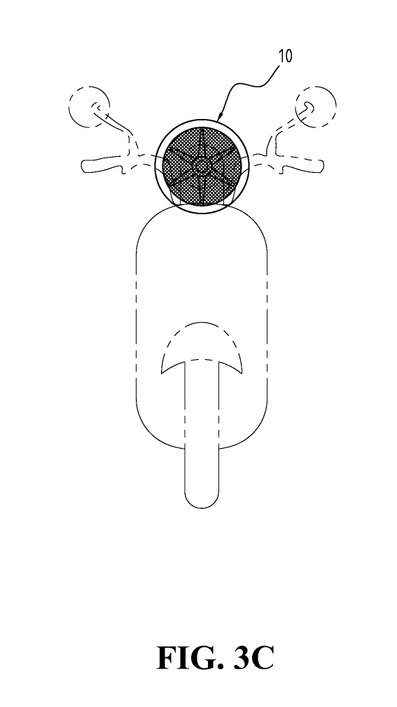

Referring to FIGS. 1A-1B, 2, and 3A-3C, a wind power generating module 10 for use with an electric scooter according to the present invention is a portable wind power generating module and thus can be installed at any appropriate position of an electric scooter. The following description of the wind power generating module 10 is exemplified by an electric motorcycle. The wind power generating module 10 is installed above the electric motorcycle head and thus functioning as a semi wind shield, at the electric motorcycle handle, outside the electric motorcycle front board, or inside the electric motorcycle front board. External air is introduced into the wind power generating module 10 while the electric motorcycle is moving. The current of the external air drives the fan blades 101 to rotate. The rotation of the fan blades 101 drives the rotor of a disc type generator 103 to rotate. Hence, the disc type generator 103 is capable of generating electric power. According to the present invention, the wind power generating module 10 comprises at least one fan blade 101, the disc type generator 103, a duct 105, a front protective cover 107a, and a rear protective cover 107b, which are described hereunder.

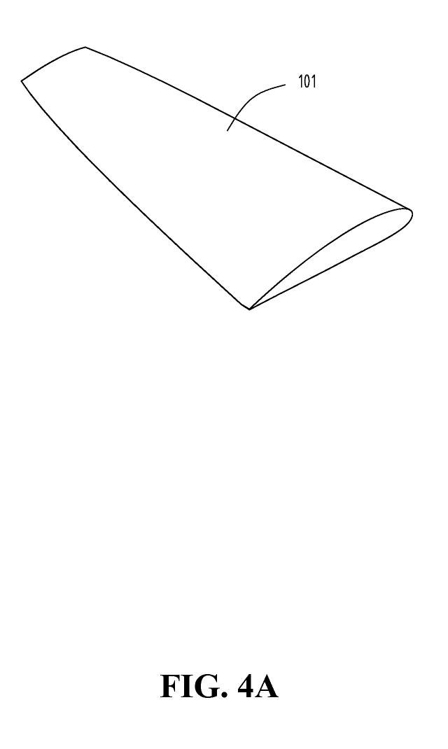

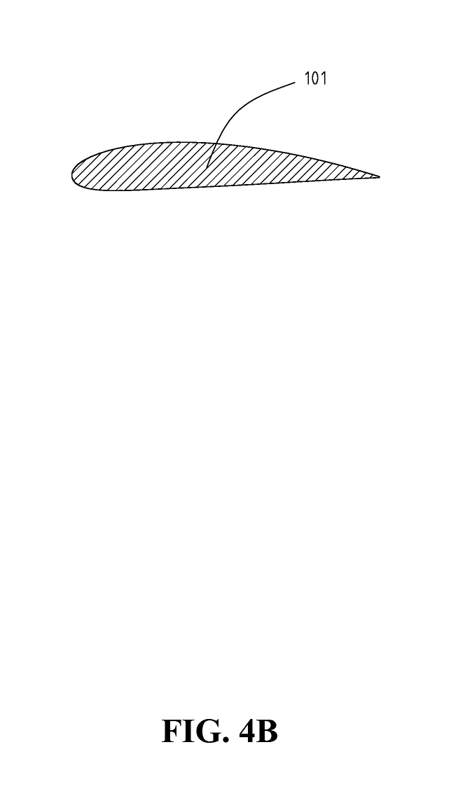

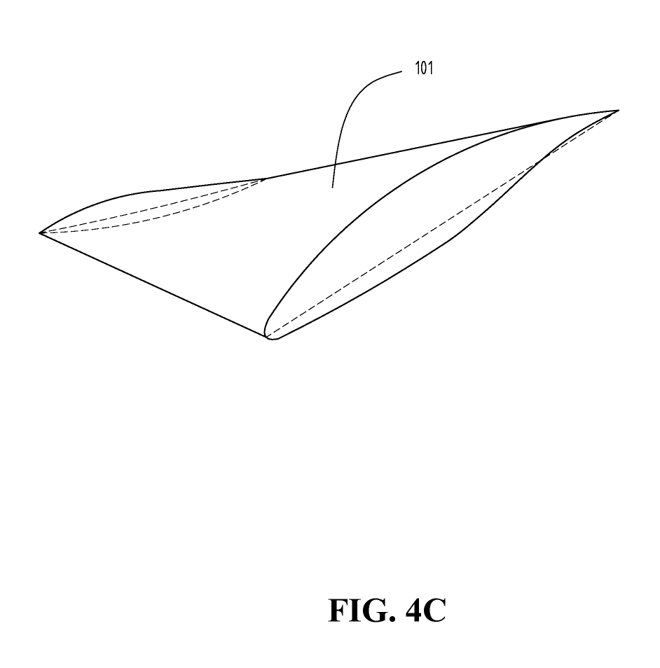

The fan blades 101 rotate when driven by the flowing external air current. The fan blades 101 consist of a plurality of the fan blades 101. The fan blades 101 each have a wing-shaped cross-section. Referring to FIG. 4A is a perspective view of a fan blade of the wind power generating module for use with an electric scooter in an embodiment according to the present invention. FIG. 4B is a cross-sectional view of the fan blade shown in FIG. 4A. Referring to FIG. 4C, which is a schematic view of the fan blade of the wind power generating module for use with an electric scooter in a variant embodiment according to the present invention, the fan blades 101 each have a twist angle. In practice, the fan blades 101 can also be conventional fan blades. Of course, the fan blades 101 of the present invention are not limited to those shown in FIG. 4A through FIG. 4C; instead, all equivalent changes made by persons skilled in the art to the aforesaid embodiments of the present invention shall fall within the scope of the present invention.

The disc type generator 103 and a wheel hub 101a of the fan blades 101 are coupled together. Once the fan blades 101 start to rotate, the rotation of the fan blades 101 will drive the rotor of the disc type generator 103 to rotate, thereby causing the disc type generator 103 to generate electric power. In practice, the disc type generator 103 can also be a conventional disc type generator. In addition, the disc type generator 103 can be replaced by any other type of power generators.

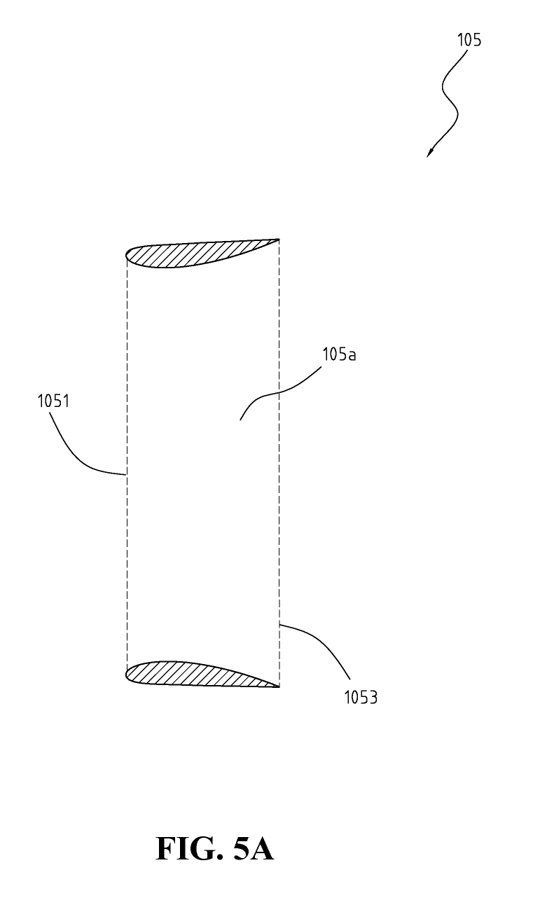

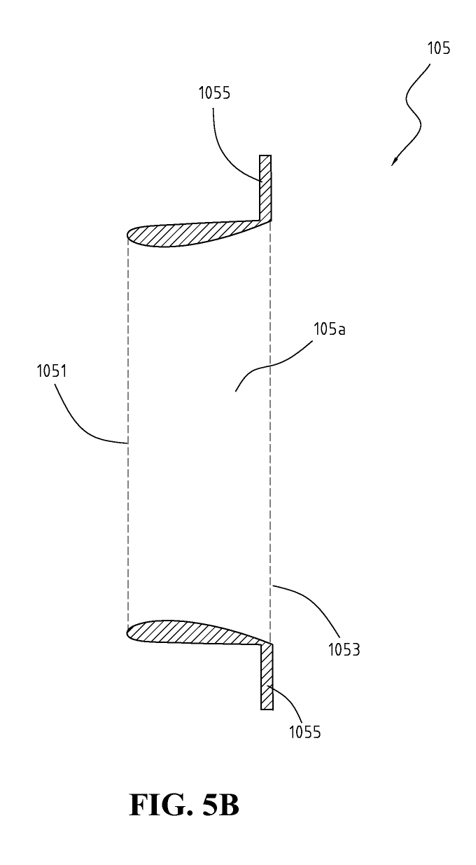

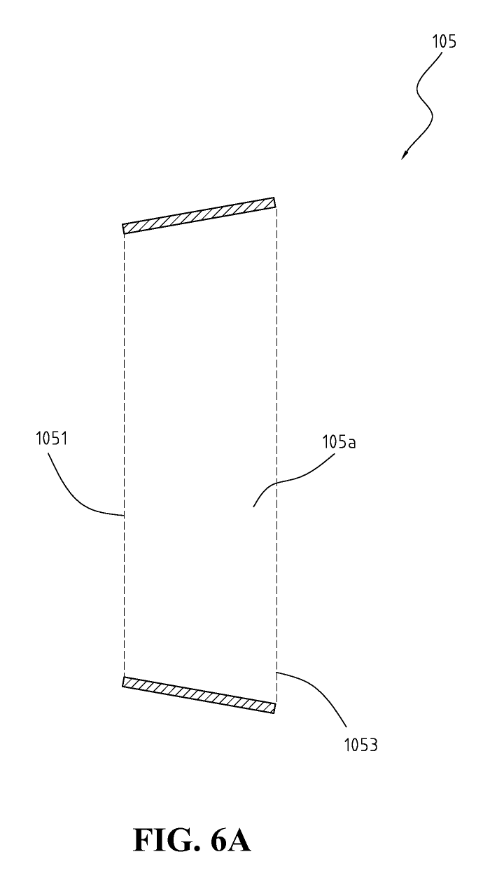

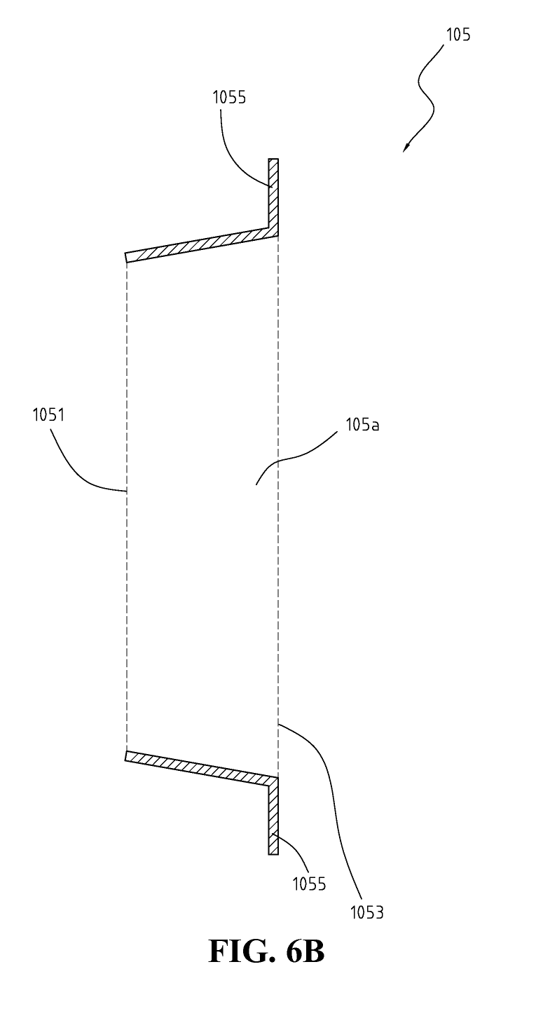

The duct 105 is circumferentially disposed at an outermost portion of the fan blades 101, and has an opening 105a. The opening 105a receives the fan blades 101. The duct 105 is spaced apart from the outermost portion of the fan blades 101 by a gap. The fan blades 101 can rotate within the opening 105a freely. Referring to FIG. 5A through FIG. 6B, the opening 105a has a front opening portion 1051 functioning as an inlet for the external air, and a rear opening portion 1053 functioning as an outlet for the external air. Hence, a wind-incoming plane of the fan blades 101 is provided by the front opening portion 1051, and a wind-outgoing plane of the fan blades 101 is provided by the rear opening portion 1053. The front opening portion 1051 is smaller than the rear opening portion 1053. The duct 105 has a hollow core, for example.

With the front opening portion 1051 being smaller than the rear opening portion 1053, air current moves into the front opening portion 1051 and out of the rear opening portion 1053 fast to thereby enhance the rotational efficiency of the fan blades 101, thereby increasing the power generation capacity of the disc type generator 103.

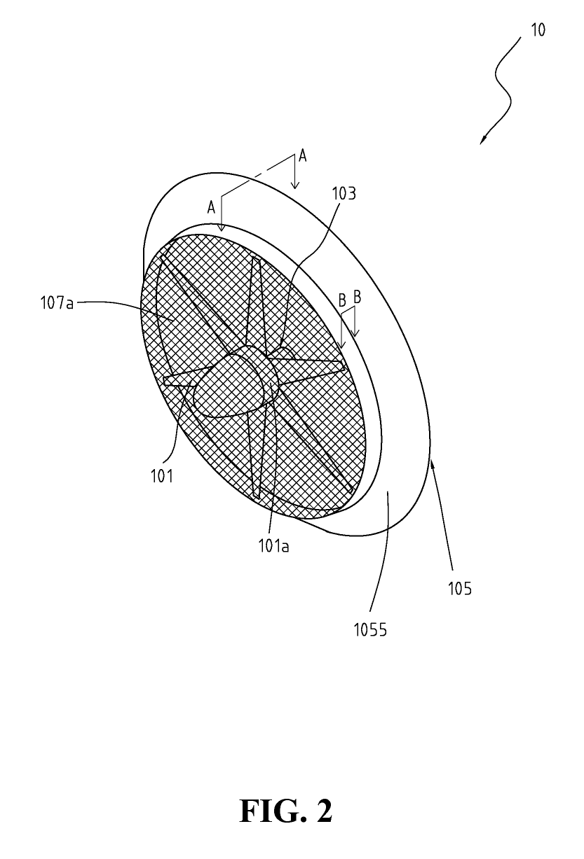

FIG. 5A is a cross-sectional view of a duct of the wind power generating module for use with an electric scooter, taken along line B-B of FIG. 2, in an embodiment according to the present invention. FIG. 5B is a cross-sectional view, taken along line A-A of FIG. 2, of protruding portions additionally provided to the duct 105 shown in FIG. 5A. The cross-section of the duct 105 is wing-shaped or arc-shaped. Referring to FIG. 5B, the external edge of the duct 105 is further provided with protruding portions 1055, and the protruding portions 1055 protrude outward from the external edge of the duct 105.

FIG. 6A is a cross-sectional view of the duct of the wind power generating module for use with an electric scooter in another embodiment according to the present invention. FIG. 6B is a cross-sectional view of the protruding portions additionally provided to the duct shown in FIG. 6A. The duct 105 has a trapezoidal hollow core. Furthermore, the external edge of the duct 105 is further provided with the protruding portions 1055. The protruding portions 1055 protrude outward from the external edge of the duct 105.

Of course, the duct 105 of the present invention is not limited to those shown in FIG. 5A through FIG. 6B; instead, all equivalent changes made by persons skilled in the art to the aforesaid embodiments of the present invention shall fall within the scope of the present invention.

The front protective cover 107a and the rear protective cover 107b are disposed at the inlet of the front opening portion 1051 and the outlet of the rear opening portion 1053, respectively.

The wind power generating module 10 of the present invention further comprises a rechargeable battery 109. The rechargeable battery 109 is electrically connected to the disc type generator 103. The purpose of the s rechargeable battery 109 is to store the electric power generated by the disc type generator 109. In practice, the rechargeable battery 109 is a built-in rechargeable battery disposed in an electric scooter.

The electric scooter of the present invention is exemplified by an electric motorcycle, an electric bicycle, an electric 3 wheel scooter, an electric 4 wheel scooter, or an electric recreational scooter.

In addition to an electric scooter, the wind power generating module 10 of the present invention is configured for use with any moving vehicle, such as a bicycle, a motorcycle, or a car, and is also configured to be placed outdoors as appropriate, so as to drive a power generator to generate electric power by natural air feeding and thus function as a power supplying device.

According to the present invention, external air is introduced into the wind power generating module while the electric scooter is moving, the current of the external air drives the fan blades to rotate. Also, the wind power generating module has a duct for enhancing the rotational efficiency of the fan blades to thereby increase the power generation capacity of a disc type generator, which are the marked improvements in the present invention in comparison with the prior art.

The foregoing descriptions of the detailed embodiments are provided to illustrate and disclose the features and functions of the present invention and are not intended to be restrictive of the scope of the present invention. All obvious and equivalent changes and modifications made in the above embodiments of the present invention by persons skilled in the art shall be interpreted as not departing from the substantive contents of the present invention.

What is claimed is:

1. A wind power generating module for use with an electric scooter, the wind power generating module being disposed on an electric scooter, comprising:
at least one fan blade, being driven to rotate by a current of external air, wherein the external air is introduced into the wind power generating module while the electric scooter is moving;
a disc type generator having a rotor configured to rotate in conjunction with the fan blades and generate electric power;
a duct circumferentially disposed at an outermost portion of the fan blades and having an opening, the opening receiving the fan blades, wherein the opening has a front opening portion functioning as an inlet for the external air and a rear opening portion functioning as an outlet for the external air, the front opening portion being smaller than the rear opening portion; and
a front protective cover and a rear protective cover disposed at the inlet and the outlet, respectively.

2. The wind power generating module of claim 1, wherein the fan blades each have a wing-shaped cross-section and a twist angle.

3. The wind power generating module of claim 1, wherein the disc type generator and a wheel hub of the fan blades are coupled together.

4. The wind power generating module of claim 1, wherein the disc type generator is replaceable by any other type of power generators.

5. The wind power generating module of claim 1, wherein the duct further comprises a protruding portion disposed at an external edge of the duct to thereby protrude outward therefrom.

6. The wind power generating module of claim 1, wherein the duct has a cross-section of a shape selected from the group consisting of a wing-like shape, an arc-like shape, and a rectangular shape.

7. The wind power generating module of claim 1, wherein the duct has a hollow core.

8. The wind power generating module of claim 1, wherein the duct is spaced apart from an outermost portion of the fan blades by a gap.

9. The wind power generating module of claim 1, further comprising a rechargeable battery electrically connected to the disc type generator and configured to store electric powder generated by the disc type generator.

10. The wind power generating module of claim 1, wherein the electric scooter is one selected from the group consisting of an electric motorcycle, an electric bicycle, an electric 3 wheel scooter, an electric 4 wheel scooter, and an electric recreational scooter.

11. The wind power generating module of claim 1, wherein the duct enables the external air to flow faster and enhances rotational efficiency of the fan blades to thereby increase power generation capacity of the disc type generator.
